(19) United States
(12) Patent Application Publication
(10) Pub. No.: US 2011/0198836 A1
(43) Pub. Date: Aug. 18, 2011

(54) APPARATUS, SYSTEM, AND METHOD FOR A BASEBALL SCOREBOOK

(76) Inventor: A. Jeffrey Smith, Salt Lake City, UT (US)

(21) Appl. No.: 13/029,396

(22) Filed: Feb. 17, 2011

Related U.S. Application Data
(60) Provisional application No. 61/305,472, filed on Feb. 17, 2010.

(51) Int. Cl. B42D 15/00

(52) U.S. Cl. 283/67; 283/49

(57) ABSTRACT

An apparatus, system, and method are disclosed for a baseball scorebook. The apparatus includes a lineup card with an identifier area, and a scoresheet having at least one identifier area. One of the lineup card or scoresheet includes a carbonless copying feature that copies the identifiers to a sheet in contact with the lineup card. The apparatus also includes a binding aligning the lineup card and the scoresheet such that the identifier areas overlays each other. The system includes the apparatus, and additional scoresheets for a team and an opposing team. A binding binds the scoresheets and additional scoresheets into a scorebook. The method includes providing a lineup card having an identifier area, providing a scoresheet having an identifier area, transferring the identifiers to a sheet in contact with the lineup card, and providing a binding that aligns the lineup card and the scoresheet.

### CROSS-REFERENCES TO RELATED APPLICATIONS

This application claims priority to U.S. Provisional Patent Application No. 61/305,472 entitled “APPARATUS, SYSTEM, AND METHOD FOR A BASEBALL SCOREBOOK” and filed on Feb. 17, 2010 for A. Jeffrey Smith, which is incorporated herein by reference.

### BACKGROUND

1. Field of the Invention

This invention relates to score sheets and more particularly relates to a scorebook that integrates a multi-part lineup card that transfers a lineup, written once, to multiple lineup cards and the score sheet.

2. Description of the Related Art

Part of the fun of baseball is recording and comparing statistics of players. The recording of statistics is known as scorekeeping. Scorekeeping is typically done on a printed scoresheet, however, software exists for scorekeeping. In general, a scorekeeper tracks: (1) general game information such as date and time, location, etc.; (2) batting lineups; (3) play-by-play action; (4) individual batting statistics; and (5) pitching statistics.

Scorekeeping, as with other human endeavors, is prone to human error. One area of scorekeeping that is prone to error is the generation of the lineup card. Before a game begins, a coach typically creates multiple lineup cards. For example, the coach might need to create a lineup card for the umpire, coach of the opposing team, official scorekeeper or official, and the coach's own team in the dugout. As a result of writing multiple lineup cards, a coach may inadvertently transpose the batting order on the lineup card. Additionally, generating multiple lineup cards is a time consuming affair that takes away the attention of the coach during critical pre-game warmups.

### SUMMARY

From the foregoing discussion, it should be apparent that a need exists for an apparatus, system, and method for a baseball scorebook. The present disclosure has been developed in response to the present state of the art, and in particular, in response to the problems and needs in the art that have not yet been fully solved by currently available scorebooks.

The apparatus includes a lineup card having at least one identifier area to receive player identifiers in a game, and a scoresheet having at least one identifier area to receive the player identifiers. At least one of the lineup card or the scoresheet comprises a carbonless copying feature that automatically copies the identifiers to a sheet in contact with the lineup card as the player identifiers are written on the lineup card. The apparatus may also include a binding aligning the lineup card and the scoresheet such that the identifier area of the lineup card overlays the identifier area of the scoresheet.

In one embodiment, the lineup card is in contact with the scoresheet. Additionally, or alternatively, the apparatus may include one or more additional lineup cards disposed between the lineup card and the scoresheet, where at least one of the additional lineup cards includes a carbonless copying feature that automatically copies the identifiers to the scoresheet as the identifiers are placed on the lineup card. In one example, a top lineup card transfers a copy of a lineup to each lineup card and the scoresheet.

The apparatus may include multiple scoresheets for a first team and a second team. In one embodiment, the second scoresheet is oriented in an upside-down configuration in relation to the first scoresheet. Furthermore, the lineup card may include a plurality of identifier areas, each identifier area configured to receive a player identifier. Additionally, the scoresheet may include a row of scoreboxes for each identifier area, each scorebox configured to maintain a batter's count for one inning.

A system of the present disclosure is also presented. In particular, the system, in one embodiment, includes a plurality of lineup cards having at least one identifier area to receive player identifiers in a game, and a plurality of scoresheets and opposing team scoresheets, each having at least one identifier area to receive the player identifiers. The system also includes a binding aligning the plurality of lineup cards, the scoresheets and the opposing team scoresheets to form a scorebook. The binding may overlay the at least one identifier area of the plurality of lineup cards with at least one of the identifier areas of the plurality of scoresheets. The system also includes, in one embodiment, a carbonless copying feature that automatically copies the identifiers to a sheet in contact with the lineup card as the player identifiers are written on the lineup card.

A method of the present disclosure is also presented. The method in the disclosed embodiments substantially includes the steps necessary to carry out the functions presented above with respect to the operation of the described apparatus and system. In one embodiment, the method includes providing a lineup card having at least one identifier area to receive player identifiers in a game, and providing a scoresheet having at least one identifier area to receive the player identifiers.

The method may also include transferring the identifiers to a sheet in contact with the lineup card as the player identifiers are written on the lineup card, and providing a binding that aligns the lineup card and the scoresheet such that the identifier area of the lineup card overlays the identifier area of the scoresheet. In a further embodiment, the method includes providing one or more additional lineup cards disposed between the lineup card and the scoresheet, and wherein at least one of the additional lineup cards comprises a carbonless copying feature that automatically copies the identifiers to the scoresheet as the identifiers are placed on the lineup card, and transferring a copy of a lineup to each of the additional lineup cards and the scoresheet. In yet another embodiment, the method includes orienting the second scoresheet in an upside-down configuration in relation to the first scoresheet.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a description will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a view illustrating one embodiment of a baseball scorebook in accordance with the present invention;

FIG. 2 is a view further illustrating an embodiment of the baseball scorebook of FIG. 1 with additional lineup cards in accordance with the present invention;

FIG. 3 is a view further illustrating one embodiment of the lineup card of FIG. 1 in accordance with the present invention;

FIG. 4 is a view further illustrating one embodiment of the scoresheet of FIG. 1 in accordance with the present invention;

FIG. 5 is a view further illustrating one embodiment of the baseball scorebook of FIG. 1 in accordance with the present invention;

FIG. 6 is a view further illustrating one embodiment of the scorebox of FIG. 4 in accordance with the present invention;

FIG. 7 is a block diagram illustrating another embodiment of a scoresheet;

FIG. 8 is a block diagram illustrating one embodiment of a scoresheet for an opposing team; and

FIG. 9 is a schematic flow chart diagram illustrating one embodiment of a method for transferring a lineup from a top lineup card to a scoresheet.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

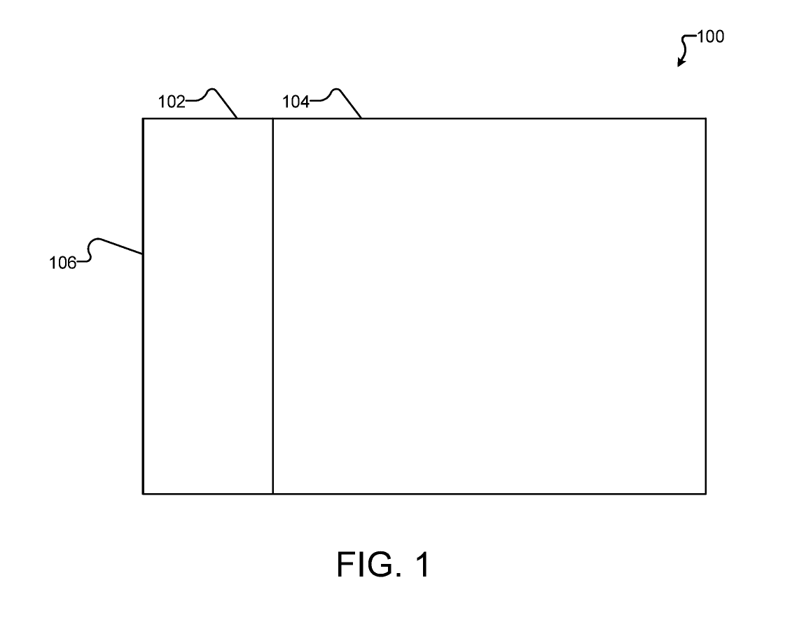

FIG. 1 is a block diagram illustrating one embodiment of a baseball scorebook 100. The baseball scorebook 100 includes a lineup card 102 and a scoresheet 104. The baseball scorebook 100 automatically transfers identifiers for players from the lineup card 102 to the scoresheet 104 in response to writing of the identifiers on the lineup card 102. The binding 106 aligns the lineup card 102 and the scoresheet 104 so that identifier areas of the lineup card overlay the identifier areas of the scoresheet.

The lineup card 102, in one embodiment, includes one or more areas for writing an identifier for a player in a baseball game. The identifier may be a name, a number, a position ID, or a different identifier that identifies a player. The lineup card 102, in one embodiment, includes a carbonless copying feature that transfers writing placed on the lineup card 102 to a sheet behind the lineup card 102. For example, the scoresheet 104 may be the sheet behind the lineup card 102, and as indicators for players are written on the lineup card 102, the carbonless copying feature transfers the indicators to the scoresheet 104.

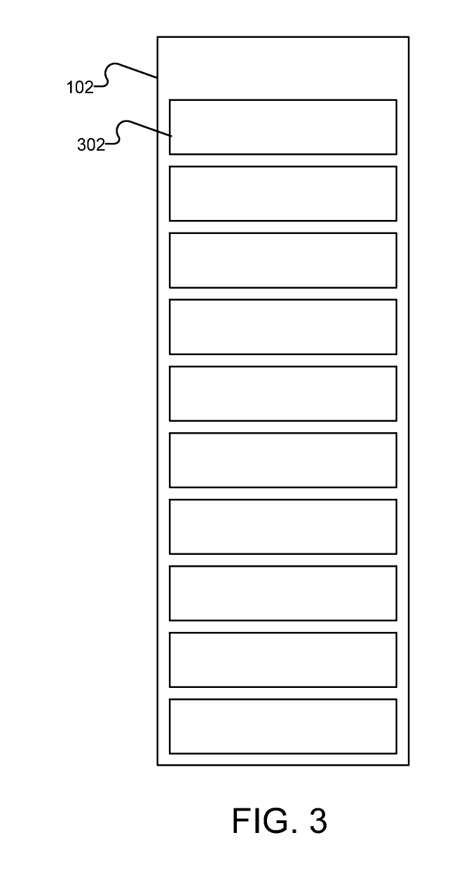

Alternatively, multiple lineup cards may be inserted between the top lineup card 102 and the scoresheet 104, with each lineup card 102 capable of transferring writing to a lower sheet. As such, an identifier written on the top lineup card 102 transfers through to each sheet between the top lineup card 102 and the scoresheet 104. The lineup card 102 is described in greater detail below with reference to FIG. 3.

The carbonless copying feature may include any type of carbonless copy technology. For example, a back surface of the lineup card 102 may include a micro encapsulated ink. In this example, as the front surface of the lineup card 102 is written upon, the micro encapsulated ink is released and transferred to the sheet behind the lineup card 102. Another example of a carbonless copy technology includes, but is not limited to, a reactive clay that reacts with an ink or a dye released by the lineup card 102 as the lineup card is written upon.

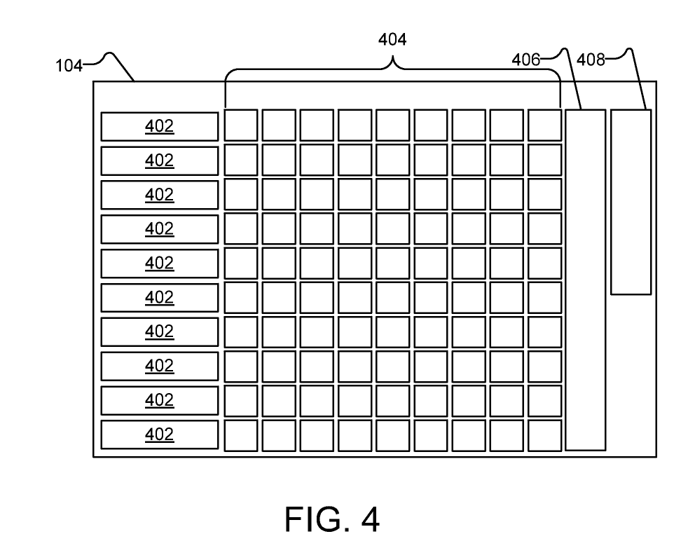

The scoresheet 104, in some embodiments, automatically receives writing transferred from the lineup card 102 to areas designated to receive identifiers for players in a baseball game. Writing from the lineup card 102 is transferred to the scoresheet 104 via a carbonless copy feature. The scoresheet 104 is described in greater detail in relation to FIG. 4. By incorporating the carbonless copy feature, the baseball scorebook 100 allows a user to avoid manually copying a lineup multiple times for, in one example, the umpire, the opposing team, and the score sheet. This saves the user tedious work and helps to eliminate errors created in manual copying.

In some embodiments, the scoresheet 104 is connected to the lineup card 102 by a binding 106. The binding 106, in one embodiment, aligns the lineup card 102 with the scoresheet 104 so that indicators transferred from the lineup card 102 to the scoresheet 104 are placed in a desired location. The binding 106 may be any type of binding used to bind sheets of paper together. For example, the binding 106 may be a comb binding or a coil binding. In some embodiments, the binding 106 is a type of binding that allows the scorebook 100 to open 360° and/or lie flat.

In the illustrated embodiment, the binding 106 is on the left side of the scoresheet 104. In an alternative embodiment, the binding 106 is on the top side of the scoresheet 104. In another embodiment, the binding 106 is on the bottom side of the scoresheet 104.

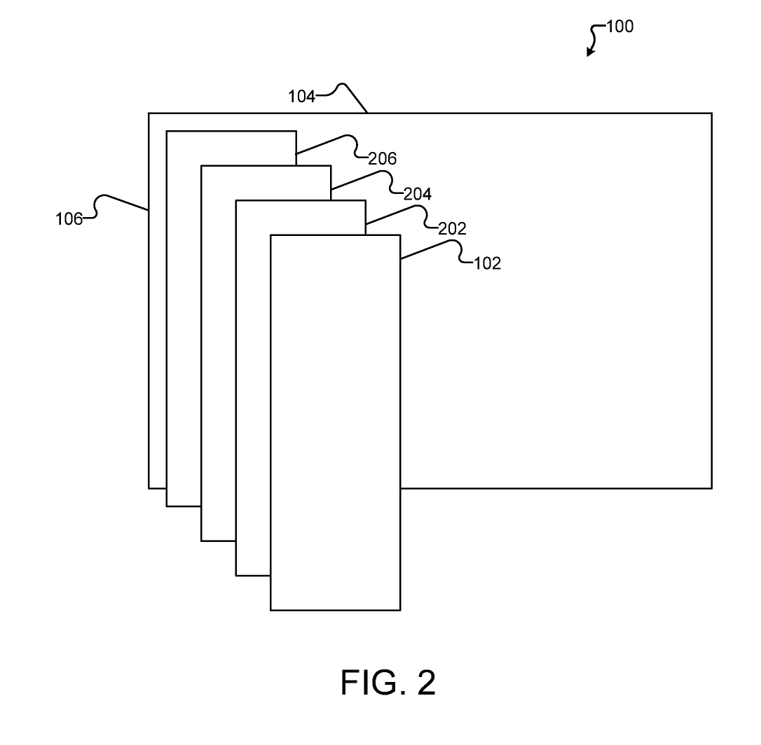

FIG. 2 is a view further illustrating an embodiment of the baseball scorebook 100 of FIG. 1 with additional lineup cards 202, 204, 206. The additional lineup cards 202, 204, 206 allow the user to automatically create additional copies of the lineup for distribution to those who may require the additional lineup cards 202, 204, 206. For example, the lineup card 102 may be designated for an umpire, while a second lineup card 202 may be designated for an opposing coach, a third lineup card 204 may be designated for the dugout, and a fourth lineup card 206 may be designated for a game official.

One or more of the lineup cards 102, 202, 204, 206, in one embodiment, may include a carbonless copying feature. For example, each of the lineup card 102, the second lineup card 202, the third lineup card 204, and the fourth lineup card 206 may include a carbonless copying feature such that writing on the lineup card 102 is transferred to each of the second lineup card 202, the third lineup card 204, the fourth lineup card 206, and the scoresheet 104.

In some embodiments, the binding 106 aligns each of the lineup cards 102, 202, 204, 206 with the scoresheet 104. Each of the lineup cards 102, 202, 204, 206 may be removable from the binding 106. For example, a user may write a lineup on the lineup card 102. In this example, the lineup may be transferred to each of the second lineup card 202, the third lineup card 204, the fourth lineup card 206, and the scoresheet 104. The lineup cards 102, 202, 204, 206 may be torn from the binding 106 after the lineup is written for distribution. Each lineup card 102, 202, 204, 206 may include a perforated tear line for ease in removing the lineup card, or, alternatively, the lineup cards 102, 202, 204, 206 may be completely removed from the binding.

In the illustrated embodiment, the scorebook 100 includes four lineup cards 102, 202, 204, 206 that incorporate carbonless copying features. In an alternative embodiment, the scorebook 100 includes a different number of lineup cards. For example, the scorebook may include two lineup cards, each of which incorporates carbonless copying features. The scorebook 100 may include any number of lineup cards incorporating carbonless copying features.

FIG. 3 is a view further illustrating one embodiment of the lineup card 102 of FIG. 1. The lineup card 102 includes a plurality of identifier areas 302. The lineup card 102 indicates an order of play for players in a baseball game.

Each identifier area 302, in one embodiment, includes a space for a user to write an identifier for a player. The identifier may be any identifier capable of identifying a player. For example, the identifier area 302 may include a location for one or more of a player name, a player number, or a player position. In some embodiments, the identifier area 302 includes a location for an identifier for substitute player who takes the position of a player.

In one embodiment, the lineup card 102 includes at least one identifier area 302 for writing an identifier for a player for each played position in a baseball game. For example, the lineup card 102 may include nine identifier areas 302. In another embodiment, the lineup card 102 includes at least one identifier area 302 more than the number of played positions in a baseball game. In an additional embodiment, the lineup card 102 may include any number of identifier areas 302 desired to accommodate teams that have larger numbers of players such as youth teams.

FIG. 4 is a view further illustrating one embodiment of the scoresheet 104 of FIG. 1. The scoresheet 104 includes a plurality of copied identifier areas 402, a plurality of scoreboxes 404, a player game total area 406, and an opponent pitcher game total area 408. The scoresheet 104 automatically receives player identifiers in the copied identifier areas 402 in response to a user writing player identifiers on the lineup card 102.

Each copied identifier area 402, in one embodiment, includes a space to receive an identifier for a player. The identifier may be any identifier capable of identifying a player. For example, the copied identifier area 402 may include a position for one or more of a player name, a player number, or a player position. In some embodiments, the copied identifier area 402 includes a position for an identifier for substitute player who takes the position of a player.

In one embodiment, each copied identifier area 402 includes a carbonless copying feature. For example, a copied identifier area 402 may include reactive clay that reacts with a dye from a sheet above the scoresheet 104, such as a second additional lineup card 204, in response to writing on the lineup card 102. In this example, the reaction between the dye and the reactive clay produces a visible mark, transferring the writing on the lineup card 102 to the scoresheet 104.

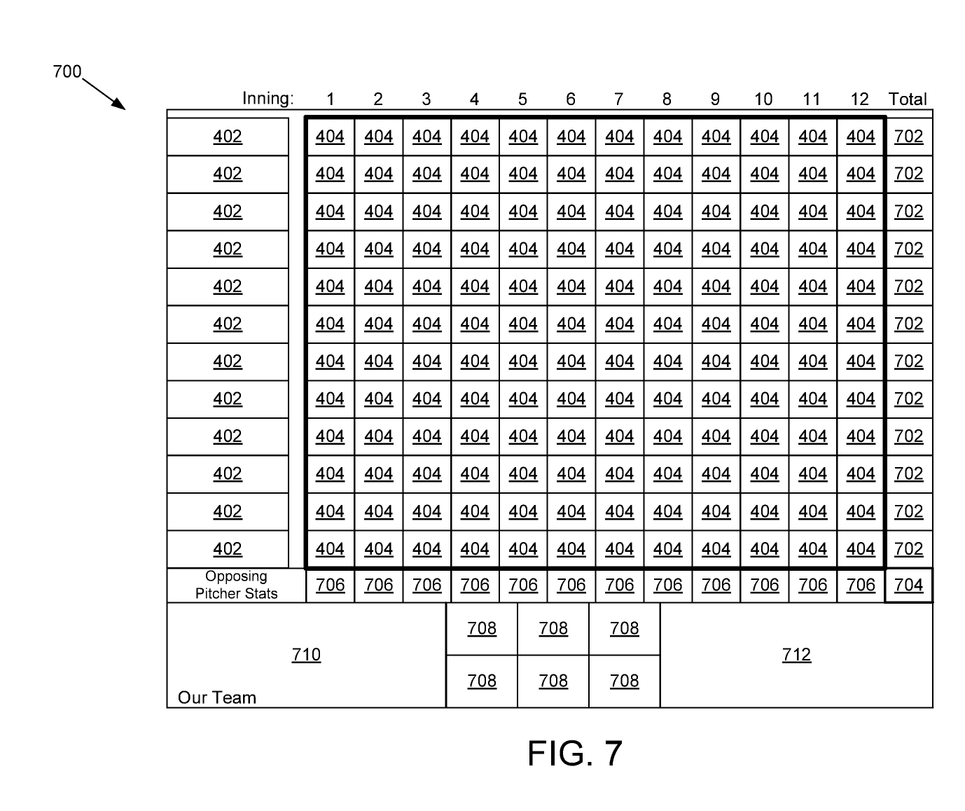

In some embodiments, each scorebox 404 includes space to record the outcome of an at-bat for a player identified in the copied identifier area 402 along the same row as the scorebox 404. The scoresheet 104 may include a column of scoreboxes 404 for each inning played in a baseball game. For example, the scoresheet 104 may include nine columns of scoreboxes 404, one column for each inning. Each column of scoreboxes 404 may include a scorebox 404 corresponding to each copied identifier area 402. An embodiment of the scorebox 404 is described in greater detail in relation to FIG. 6.

The player game total area 406, in one embodiment, provides a location to record game statistics for each player for an entire game. The player game total area 406 may include a separate area corresponding to each copied identifier area 402 at the end of a row of scoreboxes 404 corresponding to the copied identifier area 402. In some embodiments, the player game total area 406 includes positions for indicating a plurality of game statistics, such as at-bats, singles, doubles, triples, home runs, runs batted in, etc. The game statistics are easily tallied by reviewing a row of scoreboxes 404 corresponding to a particular player.

The opponent pitcher game total area 408, in some embodiments, provides a location for recording game statistics for each opposing pitcher in a game. Since the opponent pitcher game total area 408 is on the same scoresheet 104 as the scoreboxes 404 for the players, pitch statistics can be easily compiled without switching to a different page. In some embodiments, the opponent pitcher game total area 408 includes positions for indicating a plurality of pitching statistics, such as batters faced, runs allowed, earned runs, walks, wild pitches, etc. The opponent pitcher game total area 408 may include areas for recording game statistics for any number of individual pitchers. For example, the opponent pitcher game total area 408 may include areas for recording the statistics of five individual pitchers. In some embodiments, the opponent pitcher game total area 408 includes an area to record overall pitching statistics for all opponent pitchers in a game combined.

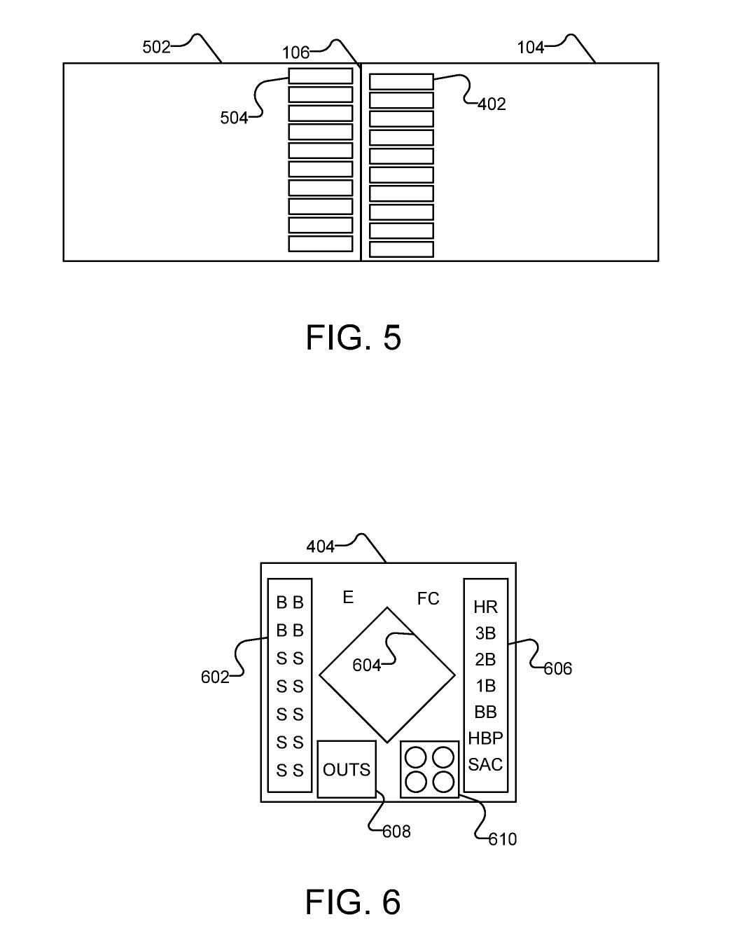

FIG. 5 is a view further illustrating one embodiment of the baseball scorebook 100 of FIG. 1. The baseball scorebook 100 includes a scoresheet 104, a binding 106 and an opponent scoresheet 502. The baseball scorebook 100 allows a user to record statistics in a baseball game for players on a baseball team and players on an opposing baseball team.

The scorecard 104, in one embodiment, includes a plurality of copied identifier areas 402 similar to same numbered elements described in relation to FIG. 4. In one embodiment, the scoresheet 104 is connected to the opponent scoresheet 502 by the binding 106.

In some embodiments, the opponent scoresheet 502 is similar to the scoresheet 104, but is oriented upside down in relation to the scoresheet 104. The opponent scoresheet 502 may include similar features located in similar locations to those on the scoresheet 104. Since the opponent scoresheet 502 is printed upside down in relation to the scoresheet 104, a user may simply flip the scoresheet 100 at the end of each half inning, thus presenting a similar layout for the scoresheet 104 and the opponent scoresheet 502. Such an arrangement allows the scorebook 100 to be used in a fully open configuration, as illustrated, or folded in half about the binding 106. In either configuration, because of the upside down orientation, a user only needs to either rotate the fully open scorebook, or flip the folded in half scorebook to look at the other scoresheet.

In one embodiment, the scoresheet 104 and the opponent scoresheet 502 include features printed in or on contrasting colors. For example, printing on the scoresheet 104 may be blue, while the printing on the opponent scorecard 502 may be green. Including contrasting colors between the scoresheet 104 and the opponent scoresheet 502 helps to differentiate between the two teams in a game, and reduces errors by the user. Additionally or alternatively, the scoresheet paper may be of one color for the different teams.

The opponent scorecard 502 may include a plurality of opponent identifier areas 504. In one embodiment, the plurality of opponent identifier areas 504 are configured for a user to write opponent player identifiers corresponding to the order opposing players are to bat. In an alternative embodiment, the scorebook 100 includes an opponent lineup card (not shown) incorporating a carbonless copying feature that transfers writing on the opponent lineup card to the plurality of opponent identifier areas 502.

FIG. 6 is a view further illustrating one embodiment of the scorebox 404 of FIG. 4. The scorebox 404 includes a pitch tracking area 602, a baserunning area 604, an at-bat outcome area 606, an out tracking area 608 and a runs batted in (RBI) area 610. The scorebox 404 allows a user to track statistics during an at-bat and baserunning for a player.

The pitch tracking area 602, in some embodiments, includes a plurality of indicators for pitches. The pitch tracking area 602 may include indicators for balls and indicators for strikes. In one embodiment, the pitch tracking area 602 includes four indicators for balls and three or more indicators for strikes. A user may mark off an indicator in response to a pitch being ruled a ball or a strike. The pitch tracking area 602 may include indicators for any number of strikes, since an at-bat may include any number of strikes due to foul balls. In one embodiment, the pitch tracking area 602 includes indicators for ten strikes. By indicating all pitches in an at-bat, including foul balls after two strikes, the pitch tracking area 602 provides a location for recording statistics that can be used to track pitches thrown by a pitcher.

The baserunning area 604, in one embodiment, provides a mechanism for tracking the position of a baserunner. The baserunning area 604 may include a diamond corresponding to basepaths and bases. A user may draw a line on the diamond from the bottom of the diamond, corresponding to home plate, to each corner of the diamond as the runner advances.

In one embodiment, the at-bat outcome area 606 includes indicators for indicating the outcome of an at-bat. For example, the at-bat outcome area 606 may include indicators for home run, triple, double, single, walk, hit by pitch, sacrifice fly, etc. A user may mark of an indicator in the at-bat outcome area 606 corresponding to the outcome of the at-bat. In some embodiments, the scorebox 406 includes additional indicators, such as indicators for fielder's choice and/or error. These additional indicators may be in an area separate from the at-bat outcome area 606, or may be included in the at-bat outcome area 606.

The out tracking area 608, in one embodiment, provides a location for indicating that a batter is ruled out. For example, a user may write a number corresponding to an out number in an inning when the player corresponding to the scorebox 404 is ruled out.

In some embodiments, the RBI area 610 provides a location for indicating that a batter had one or more RBIs in the at-bat. For example, the RBI area 610 may include four open circles that may be filled in by a user, each filled-in circle representing an RBI.

FIG. 7 is a block diagram illustrating another embodiment of a scoresheet 700. The scoresheet 700, in one embodiment, is arranged in a manner similar to that of the scoresheet 104 of FIG. 4, including identifier areas 402 and scoreboxes 404 similar to same numbered elements described in relation to FIG. 4. The scoresheet 700 may include, as depicted, 12 identifier areas 402 and 12 columns of scoreboxes 404 which allow for tracking the stats of 12 players through 12 innings. The number of identifier areas 402 and scoreboxes 404 may be selected based upon the type of game played, and/or the size of the scoresheet 700.

As described above, individual stats may be tallied across a row of scoreboxes 404 in the corresponding total box 702. Likewise, the team stats may be quickly tallied across the column of total boxes 702 in a team total box 704. Examples of stats that may be tallied in the total box 702 or the team total box 704 include, but are not limited to, at-bats, runs, hits, runs batted in, base on balls, strike outs, stolen bases, and errors.

The scoresheet 700, in one embodiment, may include an area for tallying the stats for opposing pitchers. The opposing pitcher box 706 includes information including the pitcher(s) for the opposing team during each inning, and the pitch count. Additionally, the runs, hits, and errors for each pitcher may be tracked in the opposing pitcher box 706. A pitcher's record log 708 may also be provided to track each pitcher's total number of pitches, number of innings pitched, and in which innings the opposing pitcher pitched. The scoresheet 700, as depicted, allows for tracking up to 6 different opposing pitchers via the opposing pitcher boxes 708.

An area, in one example, may also be provided for additional players. If the team has more players than available identifier areas, a coach for example, may record the additional players in an extra players box 710. In an additional embodiment, an information area 712 may maintain useful information. Examples of useful information include, but are not limited to, a legend of abbreviations used in the scoresheet and scoreboxes, a chart of positions on the baseball field, and the game score.

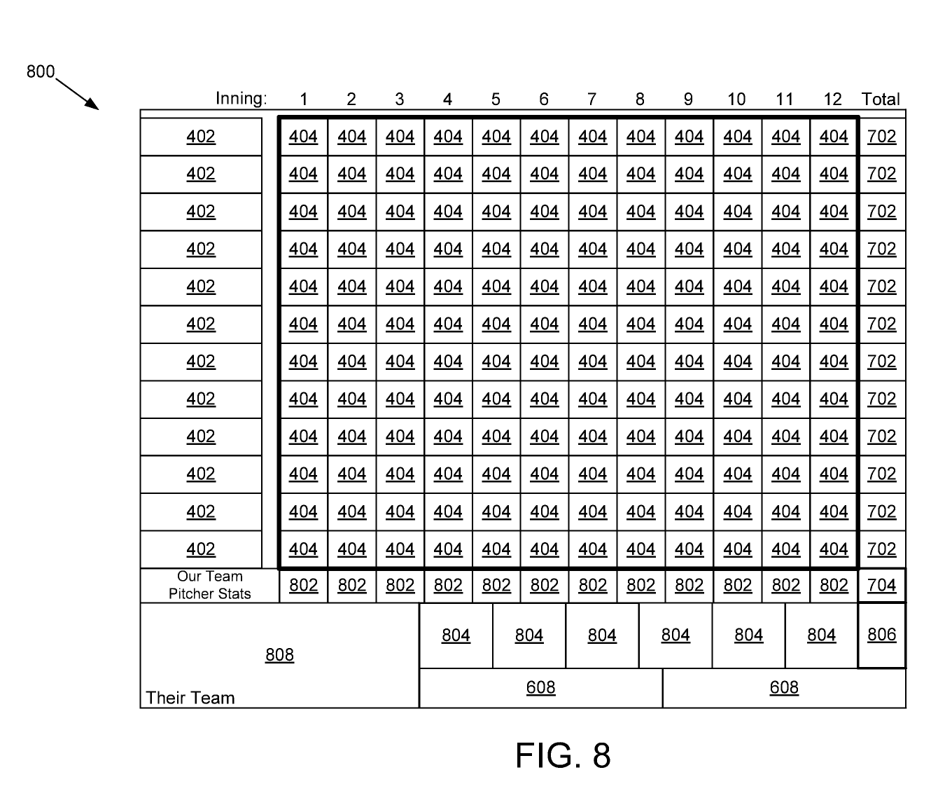

FIG. 8 is a block diagram illustrating one embodiment of a scoresheet 700 for an opposing team. The scoresheet 700, in one embodiment, contains multiple identifier areas 402, and a row of scoreboxes 404 for each identifier area 402 similar to same numbered elements described in relation to FIG. 4. As described above with reference to FIG. 7, the scoreboxes 404 are provided for tallying the stats of each individual player in each inning. A row of scoreboxes 404, therefore, represents the individual stats of a player throughout an entire game. The final individual stats may be tallied in the total box 702. Also, the stats of the entire game may be tallied in the team total box 704.

The scoresheet 800, in one embodiment, may include an area for tallying the stats for the pitchers of “our team.” The pitcher box 802 includes information including the pitcher(s) for the team during each inning, and the pitch count. Additionally, the runs, hits, and errors for each pitcher may be tracked in the pitcher box 802. A pitcher's record log 804 may also be provided to track each pitcher's total number of pitches, number of innings pitched, and in which innings the pitcher pitched. The scoresheet 800, as depicted, allows for tracking up to 6 different pitchers via the pitcher boxes 804. Additionally, the pitcher's record log 804 may also include the season long individual pitching stats including wins, loses, saves, batters faced, runs, earned runs, hits, base on balls, hits by pitch, and strike outs. Box 806 may be utilized to maintain a final tally, including information such as the final box score (runs, hits, and errors) for each team.

In a manner similar to the scoresheet 700 of FIG. 7, the scoresheet 800 may include an additional players 808 box. In a further embodiment, the scoresheet 800 includes signature areas 810 for receiving the signatures of the umpire and the opposing coach. The signatures are intended to verify the tallied stats of both scoresheets 700, 800 of FIGS. 7 and 8, respectively.

The schematic flow chart diagram included herein is generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

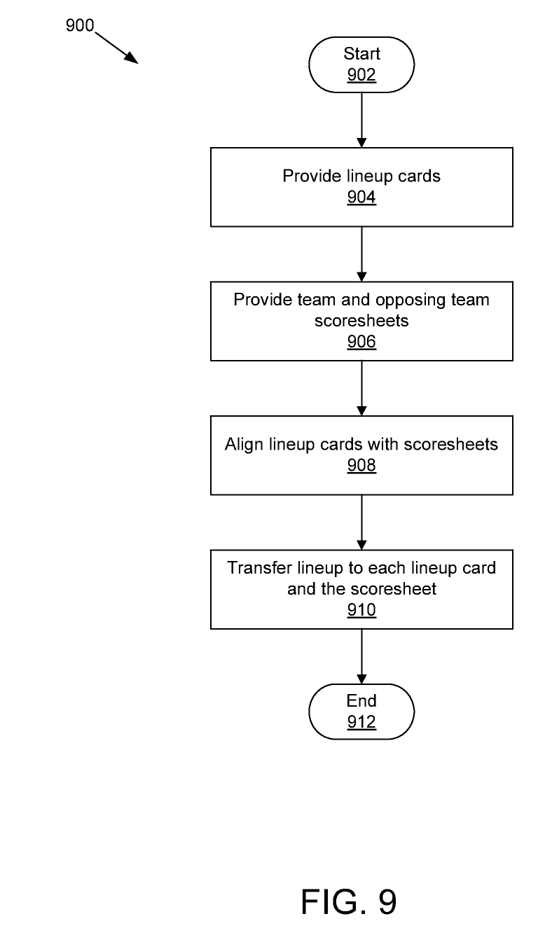

FIG. 9 is a schematic flow chart diagram illustrating one embodiment of a method 900 for transferring a lineup from a top lineup card to a scoresheet. The method 900 starts 902 and lineup cards are provided 904. In one embodiment, providing lineup cards 904 includes providing at least one lineup card as described above with reference to FIGS. 1-3. Specifically, the lineup card 102 is configured to transfer a written lineup to a writing surface engaging the bottom surface of the lineup card 102. This writing surface, as described above, may be another lineup card (see FIG. 2) or alternatively, a scoresheet. The transfer of the written lineup, in one example, is achieved using carbonless transfer techniques as described above.

The method continues and team and opposing team scoresheets are provided 906. The scoresheets of both teams at least include identifier areas that mirror the lineup cards. The lineup cards are then aligned 908 with the scoresheets. In one embodiment, aligning 908 the lineup cards with the scoresheet is achieved using a binding. The binding, for example, may be the binding 106 of FIG. 1.

The aligned lineup cards are then configured to transfer 910 the written lineup to each lineup card and finally the scoresheet. The transfer of the written lineup is accomplished using the carbonless copy technology described above. For example, a back surface of the lineup card may include a micro encapsulated ink. In this example, as the front surface of the lineup card is written upon, the micro encapsulated ink is released and transferred to the sheet behind the lineup card, which may be another lineup card or the scoresheet. Another example of a carbonless copy technology includes, but is not limited to, a reactive clay that reacts with an ink or a dye released by the lineup card as the lineup card is written upon.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a lineup card having at least one identifier area to receive player identifiers in a game;
a scoresheet having at least one identifier area to receive the player identifiers;
wherein at least one of the lineup card or the scoresheet comprises a carbonless copying feature that automatically copies the identifiers to a sheet in contact with the lineup card as the player identifiers are written on the lineup card; and
a binding aligning the lineup card and the scoresheet such that the identifier area of the lineup card overlays the identifier area of the scoresheet.

2. The apparatus of claim 1, wherein the lineup card is in contact with the scoresheet.

3. The apparatus of claim 1, further comprising one or more additional lineup cards disposed between the lineup card and the scoresheet, and wherein at least one of the additional lineup cards comprises a carbonless copying feature that automatically copies the identifiers to the scoresheet as the identifiers are placed on the lineup card.

4. The apparatus of claim 3, wherein a top lineup card transfers a copy of a lineup to each lineup card and the scoresheet.

5. The apparatus of claim 1, wherein the scoresheet comprises a first scoresheet for a first team and further comprising a second scoresheet for an opposing team.

6. The apparatus of claim 5, wherein the second scoresheet is oriented in an upside-down configuration in relation to the first scoresheet.

7. The apparatus of claim 1, wherein the lineup card comprises a plurality of identifier areas, each identifier area configured to receive a player identifier.

8. The apparatus of claim 1, wherein the scoresheet further comprises a row of scoreboxes for each identifier area, each scorebox configured to maintain a batter's count for one inning.

9. A system comprising:
a plurality of lineup cards having at least one identifier area to receive player identifiers in a game;
a plurality of scoresheets and opposing team scoresheets, each having at least one identifier area to receive the player identifiers;
a binding aligning the plurality of lineup cards, the scoresheets and the opposing team scoresheets to form a scorebook;
wherein the binding overlays the at least one identifier area of the plurality of lineup cards with at least one of the identifier areas of the plurality of scoresheets; and
wherein at least one of the lineup cards or the scoresheets comprises a carbonless copying feature that automatically copies the identifiers to a sheet in contact with the lineup card as the player identifiers are written on the lineup card.

10. The system of claim 9, wherein the lineup card is in contact with the scoresheet.

11. The system of claim 9, further comprising one or more additional lineup cards disposed between a top lineup card and a scoresheet, and wherein at least one of the additional lineup cards comprises a carbonless copying feature that automatically copies the identifiers to the scoresheet as the identifiers are placed on the lineup card.

12. The system of claim 11, wherein the top lineup card transfers a copy of a lineup to each lineup card and the scoresheet.

13. The system of claim 9, wherein each opposing team scoresheet is oriented in an upside-down configuration in relation to each corresponding scoresheet.

14. The system of claim 9, wherein the lineup card comprises a plurality of identifier areas, each identifier area configured to receive a player identifier.

15. The system of claim 9, wherein the scoresheet further comprises a row of scoreboxes for each identifier area, each scorebox configured to maintain a batter's count for one inning.

16. A method comprising:
providing a lineup card having at least one identifier area to receive player identifiers in a game;
providing a scoresheet having at least one identifier area to receive the player identifiers;
transferring the identifiers to a sheet in contact with the lineup card as the player identifiers are written on the lineup card; and
providing a binding that aligns the lineup card and the scoresheet such that the identifier area of the lineup card overlays the identifier area of the scoresheet.

17. The method of claim 16, further comprising providing one or more additional lineup cards disposed between the lineup card and the scoresheet, and wherein at least one of the additional lineup cards comprises a carbonless copying feature that automatically copies the identifiers to the scoresheet as the identifiers are placed on the lineup card.

18. The method of claim 17, further comprising transferring a copy of a lineup to each of the additional lineup cards and the scoresheet.

19. The method of claim 16, further comprising providing a first scoresheet for a first team and further comprising a second scoresheet for an opposing team.

20. The method of claim 19, further comprising orienting the second scoresheet in an upside-down configuration in relation to the first scoresheet.
